(19) United States
(12) Patent Application Publication
(10) Pub. No.: US 2025/0353323 A1
(43) Pub. Date: Nov. 20, 2025

(54) COMPOSITE SPOKE ARRAY FOR A BICYCLE WHEEL

(71) Applicant: SRAM, LLC, CHICAGO, IL (US)

(72) Inventor: DAVID MORSE, INDIANAPOLIS, IN (US)

(73) Assignee: SRAM, LLC, CHICAGO, IL (US)

(21) Appl. No.: 19/202,234

(22) Filed: May 8, 2025

Related U.S. Application Data
(60) Provisional application No. 63/647,747, filed on May 15, 2024.

(51) Int. Cl. B60B 1/00; B60B 5/02

(52) U.S. Cl. CPC B60B 1/003; B60B 5/02; B60B 2360/3416

(57) ABSTRACT

A wheel for a bicycle includes a central hub, a rim, and a first spoke array removably attached to the central hub and the rim. The first spoke array is at a first side of the wheel and includes a first central flange and a plurality of first spokes integral with and extending away from the first central flange, such that a first single part is formed. The wheel includes a second spoke array removably attached to the central hub and the radially inner portion of the rim. The second spoke array is at a second side of the wheel. The second side of the wheel is opposite the first side of the wheel. The second spoke array includes a second central flange and a plurality of second spokes integral with and extending away from the second central flange, such that a second single part is formed.

This application claims the benefit of U.S. Provisional Patent Application No. 63/647,747, filed May 15, 2024, which is hereby incorporated by reference in its entirety.

### BACKGROUND

### 1. Field of the Disclosure

The present disclosure is generally directed to a bicycle wheel, and more particularly, to a composite spoke array for a bicycle wheel.

### 2. Description of Related Art

A traditional bicycle wheel may include a rim formed of extruded metals or other materials that are bent and bonded into a circular shape having consistently shaped cross sections. Alloy spokes are attached to a hub and the rim.

Recently, other materials, such as fiber reinforced plastics, have been used in the manufacture of bicycle rims, which may be formed into circular shapes through non-extrusion based processes. Carbon fiber reinforced plastics may, for example, be used.

### SUMMARY

In one example, a wheel for a bicycle includes a central hub having a first end and a second end opposite the first end. The central hub is configured for rotational attachment to the bicycle. The wheel includes a rim including a radially inner portion disposed along an inner circumference of the rim, and a first spoke array removably attached to the central hub and the radially inner portion of the rim. The first spoke array is at a first side of the wheel and includes a first central flange and a plurality of first spokes integral with and extending away from the first central flange, such that a first single part is formed. The wheel includes a second spoke array removably attached to the central hub and the radially inner portion of the rim. The second spoke array is at a second side of the wheel. The second side of the wheel is opposite the first side of the wheel. The second spoke array includes a second central flange and a plurality of second spokes integral with and extending away from the second central flange, such that a second single part is formed.

In one example, the central hub includes a first flange and a second flange. The first flange is closer to the first end of the central hub than the second end of the central hub, and the second flange is closer to the second end of the central hub than the first end of the central hub. The first spoke array is removably attached to the first flange of the central hub, and the second spoke array is removably attached to the second flange of the central hub.

In one example, the first central flange and the plurality of first spokes of the first spoke array are made of a first material, and the second central flange and the plurality of second spokes of the second spoke array are made of a second material.

In one example, the first material and the second material are a same carbon fiber composite material.

In one example, the rim further includes a first sidewall and a second sidewall spaced apart from the first sidewall. The first sidewall and the second sidewall extend radially outward from the radially inner portion. The rim further includes a radially outer tire engaging portion disposed along an outer circumference of the rim. The radially outer tire engaging portion extends from the first sidewall and the second sidewall, respectively. The first sidewall, the second sidewall, the radially outer tire engaging portion, and the radially inner portion of the rim are made of a third material. The third material is a carbon fiber composite material.

In one example, the first central flange is a first faceted annulus, and the second central flange is a second faceted annulus.

In one example, each of the first faceted annulus and the second faceted annulus has an inner surface that is shaped as a square, a pentagon, a hexagon, a septagon, or an octagon.

In one example, the central hub further includes a first boss extending between the first flange and the first end, and a second boss extending between the second flange and the second end. An outer surface of the first boss is a same shape as the inner surface of the first faceted annulus, and an outer surface of the second boss is a same shape the inner surface of the second faceted annulus.

In one example, the first boss includes a first retention feature at the outer surface of the first boss, and the first faceted annulus includes a second retention feature at the inner surface of the first faceted annulus. The second retention feature is configured to interact with the first retention feature, such that the first spoke array is attached to the central hub. The second boss includes a third retention feature at the outer surface of the second boss, and the second faceted annulus includes a fourth retention feature at the inner surface of the second faceted annulus. The fourth retention feature is configured to interact with the third retention feature, such that the second spoke array is attached to the central hub.

In one example, the first retention feature is a first detent feature that extends into the first boss, and the second retention feature is a second detent feature that extends away from the inner surface of the first faceted annulus. The third retention feature is a third detent feature that extends into the second boss, and the fourth retention feature is a fourth detent feature that extends away from the inner surface of the second faceted annulus.

In one example, a length of a first spoke of the plurality of first spokes extends between the first central flange and the rim. A length of a second spoke of the plurality of second spokes extends between the second central flange and the rim.

In one example, a spoke array that is removably attachable to a central hub and a rim of a wheel for a bicycle, such that the spoke array forms all spokes of one side of the wheel. The spoke array includes a central flange and a plurality of spokes integral with and extending away from the central flange, such that a single part is formed.

In one example, the central flange and the plurality of spokes integral with the central flange are made of a carbon fiber composite material. The carbon fiber composite material includes a matrix of a polymer-based material and fibers of reinforcing material. The fibers of reinforcing material are carbon fibers.

In one example, a continuous fiber of the carbon fibers extends from a first spoke of the plurality of spokes to a second spoke of the plurality of spokes via the central flange.

In one example, the first spoke is at an angle relative to the second spoke.

In one example, the angle is an acute angle.

In one example, the central flange is a faceted annulus having an inner surface that is shaped as a square, a pentagon, a hexagon, a septagon, or an octagon.

In one example, the faceted annulus comprises a retention feature at an inner surface of the faceted annulus.

In one example, the retention feature is a protrusion extending from the inner surface of the faceted annulus, radially inwardly.

In one example, the protrusion is a circumferential rib extending around a circumference of the inner surface of the faceted annulus.

In one example, a spoke assembly for a bicycle includes a central hub having a first end and a second end opposite the first end. The central hub is configured for rotational attachment to the bicycle. The spoke assembly includes a spoke array removably attached to the central hub closer to the first end of the central hub than to the second end of the central hub. The spoke array includes a central flange and a plurality of spokes integral with and extending away from the central flange, such that a single part is formed.

In one example, the spoke array is a first spoke array, the central flange is a first central flange, the plurality of spokes is a first plurality of spokes, and the single part is a first single part. The spoke assembly further includes a second spoke array removably attached to the central hub. The second spoke array includes a second central flange and a plurality of second spokes integral with and extending away from the second central flange, such that a second single part is formed.

In one example, the central hub includes a first flange and a second flange. The first flange is closer to the first end of the central hub than the second end of the central hub, and the second flange is closer to the second end of the central hub than the first end of the central hub.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle that may be constructed to utilize a wheel including a spoke array;

FIG. 2 is a perspective view of an embodiment of a wheel for a bicycle, such as the bicycle of FIG. 1;

FIG. 3 is a perspective view of an embodiment of a rim of a wheel, such as the wheel of FIG. 2;

FIG. 4 is cross-section of the rim of FIG. 3;

FIG. 5 is a close-up perspective view of a portion of the wheel of FIG. 2;

FIG. 6 is a top view of a first example of a spoke array of a wheel for a bicycle, such as the wheel of FIG. 2;

FIG. 7 is a first close-up perspective view of the spoke array of FIG. 6;

FIG. 8 is a second close-up perspective view of the spoke array of FIG. 6;

FIG. 9 is a close-up perspective view of a central hub of a wheel for a bicycle, such as the wheel of FIG. 2;

FIG. 10 is a cross-section view of a first side of a spoke assembly before a spoke array is attached to a central hub;

FIG. 11 is a cross-section view of the spoke assembly of FIG. 10, after the spoke array has been attached to the central hub;

FIG. 12 is a perspective view of a second side of the spoke assembly of FIG. 10, after the spoke array has been attached to the central hub;

FIG. 13 is a top view of a second example of a spoke array;

FIG. 14 is a top view of a third example of a spoke array;

FIG. 15 is a top view of a fourth example of a spoke array;

FIG. 16 is a top view of a strip of composite material;

FIGS. 17A-17D show different examples of continuous fiber path;

FIG. 18 is a flow chart of an embodiment of a method for manufacturing a rim;

FIG. 19 is a cross-section view of a rim for a bicycle, such as the bicycle in FIG. 1;

FIG. 20 is a close-up view of a spoke to rim interface, such as the rim in FIG. 19;

FIG. 21 is a first embodiment of an interface structure, such as the interface structure seen in FIG. 19;

FIG. 22 is a second embodiment of an interface structure;

FIG. 23 is a third embodiment of an interface structure; and

FIG. 24 is a fourth embodiment of an interface structure.

### DETAILED DESCRIPTION OF THE DISCLOSURE

Carbon spokes are lighter than alloy spokes. Carbon spokes, however, are challenging to attach to a rim or a hub of a wheel for a bicycle in a modular or replaceable way.

The present disclosure provides examples of carbon composite spoke arrays and wheels that include such spoke arrays. The carbon composite spoke arrays provide modularity and are easily replaceable. For example, a bicycle wheel including two composite spoke arrays forming spokes on opposite sides of the bicycle wheel is provided. Each of the composite spoke arrays includes composite spokes arranged to structurally intersect a faceted annulus about a rotational axis of a hub of the bicycle wheel. The composite spokes may be fastened to a rim in a number of ways including, for example, threaded interfaces to nipples fixed in the rim.

The faceted annulus of the composite spoke array interfaces with the hub, such that the spoke array may be removed and replaced with standard tools. The faceted annulus may be at least partly formed as a continuation of bodies of the composite spokes formed to geometries to interface with the hub. The interface between the faceted annulus and the hub braces against torques transmitted between the hub and the spoke array.

The examples solve or improve upon one or more of the above-noted and/or other disadvantages. The disclosed spoke arrays, for example, provide modularity and ease of repair. Further, the disclosed spoke arrays may be lighter than a corresponding number of alloy spokes. The disclosed spoke arrays allow for spoke pre-load forces to be transmitted across a hub without relying on hub material to support the pre-load forces, which may allow for weight reduction of the wheel. The disclosed spoke arrays forming all spokes on one side of a wheel reduces assembly time and complexity for the wheel.

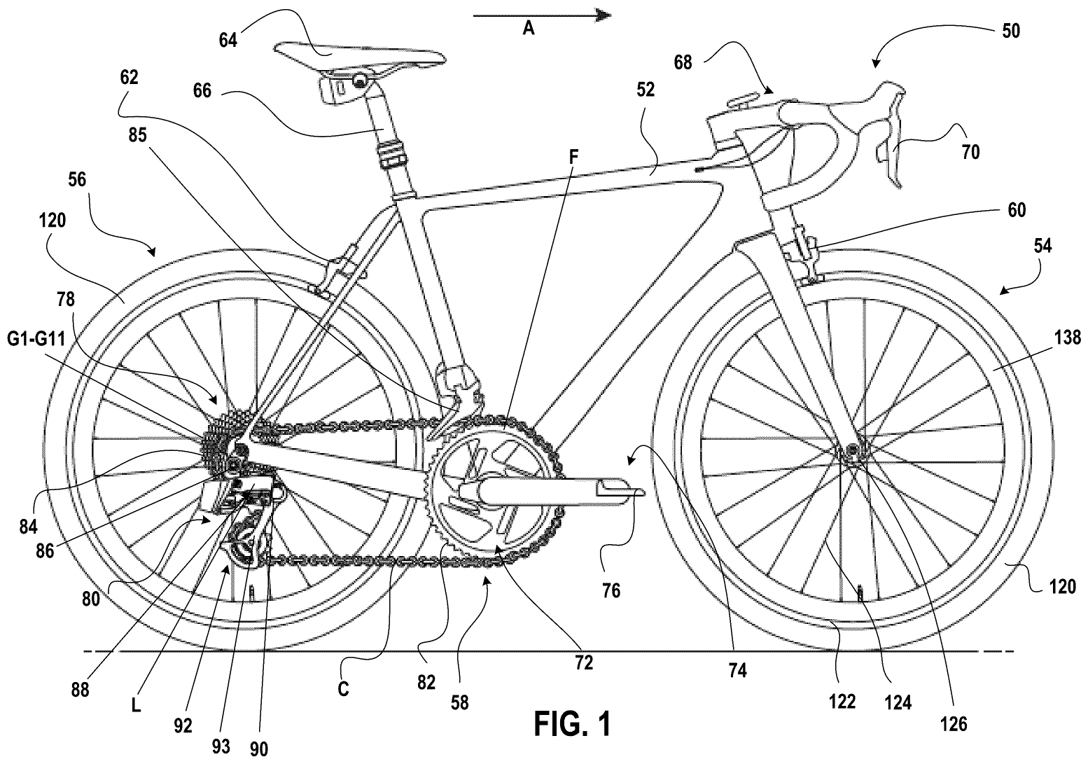

Turning now to the drawings, FIG. 1 generally illustrates a bicycle 50 that employs wheels constructed in accordance with the teachings of the present disclosure. The bicycle 50 includes a frame 52, a front wheel 54 and a rear wheel 56 each rotatably attached to the frame 52, and a drivetrain 58. A front brake 60 is provided for braking the front wheel 54, and a rear brake 62 is provided for braking the rear wheel 56. The bicycle 50 also generally has a seat 64 near a rear end of the frame 52 and carried on an end of a seat post 66 connected to the frame 52. The bicycle 50 also has handlebars 68 near a forward end of the frame 52. A brake lever 70 is carried on the handlebars 68 for actuating the front brake 60, the rear brake 62, or both the front brake 60 and the rear brake 62. If the brake lever 70 actuates only one of the front brake 60 and the rear brake 62, a second brake lever (not shown) may also be provided to actuate the other brake. A front and/or forward riding direction or orientation of the bicycle 50 is indicated by the direction of the arrow A in FIG. 1. As such, a forward direction for the bicycle 50 is indicated by the direction of arrow A. While the illustrated bicycle 50 depicted in FIG. 1 is a road bike having drop-style handlebars 68, the present disclosure may be applicable to bicycles of any type, including mountain bikes with full or partial suspensions.

The drivetrain 58 has a chain C and a front sprocket assembly 72, which is coaxially mounted with a crank assembly 74 having pedals 76. The drivetrain 58 also includes a rear sprocket assembly 78 coaxially mounted with the rear wheel 56 and a rear gear change mechanism, such as a rear derailleur 80.

As is illustrated in FIG. 1, the front sprocket assembly 72 may include one or more coaxially mounted chainrings, gears, or sprockets. In this example, the front sprocket assembly 72 has at least one sprocket F (e.g., a sprocket). The sprocket F has teeth 82 around a respective circumference. As shown in FIG. 1, the rear sprocket assembly 78 may include a plurality of coaxially mounted gears, cogs, or sprockets G. Each sprocket G1-G11 also has teeth 84 arranged around a respective circumference. The number of teeth 84 on the rear sprockets G1-G11 may gradually decrease from the largest diameter rear sprocket G1 to the smallest diameter sprocket G11. Though not described in any detail herein, a front gear changer 85 may be operated to move from a first operating position to a second operating position to move the chain C between front sprockets F. Likewise, the rear derailleur 80 may be operable to move between different operating positions to switch the chain C to a selected one of the rear sprockets G1-G11. In an embodiment, the rear sprocket assembly 78 may have more or fewer sprockets G. For example, in an embodiment, the rear sprocket assembly 78 may have twelve or thirteen sprockets. Dimensions and configuration of the rear derailleur 80 may be modified to accommodate a specific implemented plurality of sprockets. For example, an angle and length of a linkage and/or a configuration of a cage of the rear derailleur 80 may be modified to accommodate specific sprocket combinations.

The rear derailleur 80 is depicted as a wireless, electrically actuated rear derailleur mounted or mountable to the frame 52, or frame attachment, of the bicycle 50. The electric rear derailleur 80 has a base member 86 (e.g., a b-knuckle) that is mounted to the bicycle frame 52. A linkage 88 has two links L that are pivotally connected to the base member 86 at a base member linkage connection portion. A movable member 90 (e.g., a p-knuckle) is connected to the linkage 88 at a moveable member linkage connection portion. A chain guide assembly 92 (e.g., a cage) is configured to engage and maintain tension in the chain and has one or more cage plates 93 with a proximal end that is pivotally connected to a part of the movable member 90. The cage plate 93 may rotate or pivot about a cage rotation axis in a damping direction and a chain tensioning direction. Other gear changing systems, such as mechanically or hydraulically controlled and/or actuated systems may also be used.

A motor module may be carried on the electric rear derailleur 80 with a battery. The battery supplies power to the motor module. In one example, the motor module is located in the movable member 90. However, the motor module may instead be located elsewhere, such as in one of the links L of the linkage 88 or in the base member 86. The motor module may include a gear mechanism or transmission. As is known in the art, the motor module and gear mechanism may be coupled with the linkage 88 to laterally move the cage plate 93 and thus switch the chain C among the rear sprockets (e.g., G1-G11) on the rear sprocket assembly 78.

The cage plate 93 also has a distal end that carries a tensioner cog or wheel. The wheel also has teeth around a circumference. The cage plate 93 is biased in a chain tensioning direction to maintain tension in the chain C. The chain guide assembly 92 may also include a second cog or wheel, such as a guide wheel disposed nearer the proximal end of the cage plate 93 and the movable member 90. In operation, the chain C is routed around one of the rear sprockets (e.g., G1-G11). An upper segment of the chain C extends forward to the front sprocket assembly 72 and is routed around the one front sprocket F. A lower segment of the chain C returns from the front sprocket assembly 72 to the tensioner wheel and is then routed forward to the guide wheel. The guide wheel directs the chain C to the rear sprockets (e.g., G1-G11). Lateral movement of the cage plate 93, the tensioner wheel, and the guide wheel may determine the lateral position of the chain C for alignment with a selected one of the rear sprockets (e.g., G1-G11).

The bicycle 50 may include one or more bicycle control devices mounted to handlebars 68. The bicycle control devices may include one or more types of bicycle control and/or actuation systems. For example, the bicycle control devices may include brake actuation systems to control the front brake 60 and/or the rear brake 62, and/or gear shifting systems to control the drivetrain 58. Other control systems may also be included. For example, the system may be applied, in some embodiments, to a bicycle where only a front or only a rear gear changer is used. Also, the one or more bicycle control devices may also include suspension, seat post, and/or other control systems for the bicycle 50.

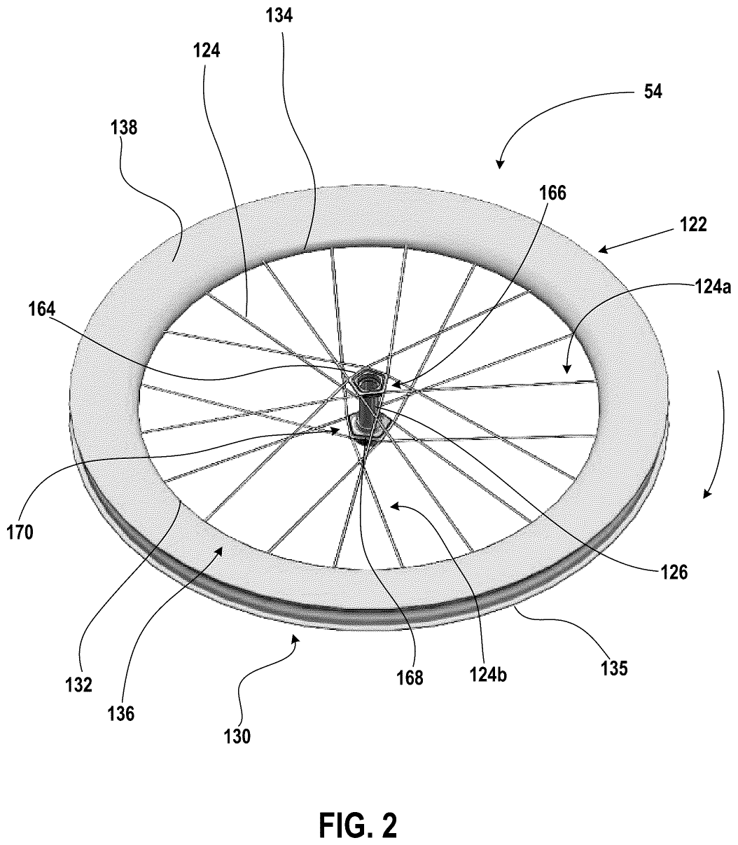

The front wheel 54 and/or the rear wheel 56 of the bicycle 50 may include a tire 120 attached to a radially outer tire engaging portion of a rim 122. The tire 120 may be any number of sizes. For example, the tire 120 may have a width that is greater than 34 mm. As shown in FIGS. 1 and 2, a plurality of spokes 124 are attached directly to the rim 122 (e.g., via threaded interfaces to metal nipples fixed in the rim 122). Alternatively, the spokes 124 may be attached and/or secured to the rim 122 with other structural components. The spokes 124 extend from the rim 122 and attach to a central hub 126. The spokes 124 are maintained with a tension between the rim 122 and the central hub 126 to provide the respective wheel 54, 56 with an operational rigidity for use on the bicycle 50. The central hub 126 is configured for rotational attachment to the bicycle frame 52.

FIG. 2 illustrates a bicycle wheel having a rim 122, spokes 124, and a central hub 126, such as the front wheel 54 of FIG. 1, removed from the rest of the bicycle 50 and without a tire attached. The rim 122 includes a tire engaging portion 130 to engage with the tire 120, as is shown in FIG. 1. The tire engaging portion 130 is configured radially outward of a spoke receiving surface 132 that is disposed along an inner circumference 134 of the rim 122. In other words, the tire engaging portion 130 is a radially outer tire engaging portion. In an embodiment, the tire engaging portion 130 is disposed along an outer circumference 135 of the rim 122. The tire engaging portion 130 is configured for attachment to tubeless tires. Other configurations of the tire engaging portion 130 may be provided for clincher tire attachment configurations for tires including beaded interlock attachments. Other configurations of the tire engaging portion 130 may also be provided to allow for the use of other types of tires on the rim 122. For example, tubeless tires including beaded interlock attachment types may be used.

The rim 122 provides structure for attachment of the spokes 124 to the rim 122 at a receiving portion of the rim 122, proximate to the spoke receiving surface 132. As such, the spoke receiving surface 132 is part of a spoke engaging portion 136 (e.g., a radially inner portion) of the rim 122. In an embodiment, the spoke engaging portion 136 of the rim 122 is disposed along the inner circumference 134 of the rim 122. In another embodiment, the spoke receiving surface 132 and the spoke engaging portion 136 may be separate parts and/or portions of the rim 122. For example, the spokes 124 may pass through the spoke receiving surface 132, and the structure for attachment to the rim 122 may be provided proximate to the tire engaging portion 130.

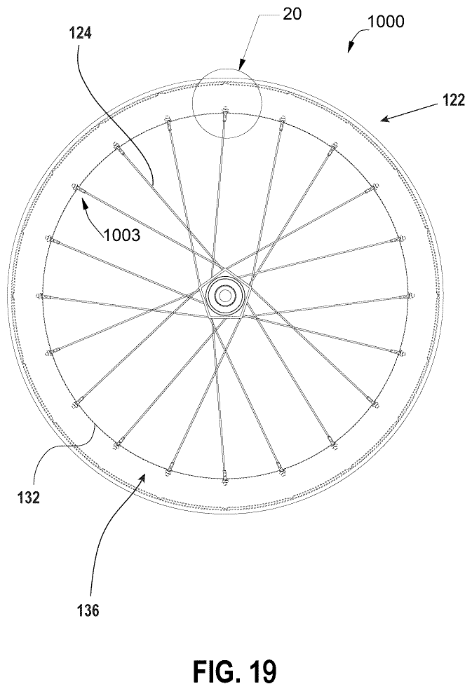

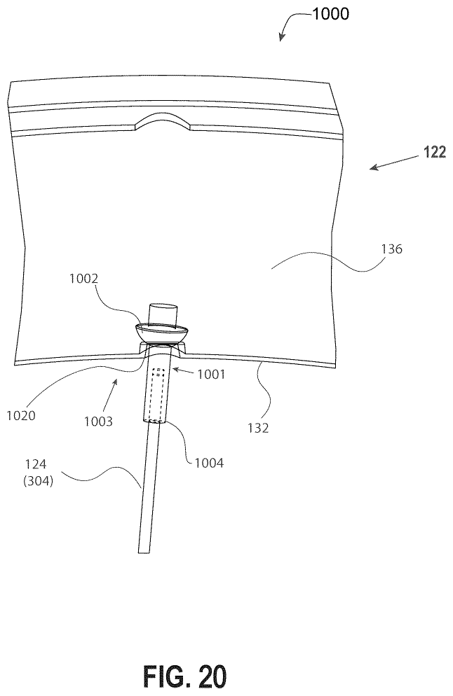

In the embodiment 1000 of FIGS. 19 and 20, the spoke engaging portion 136 of rim 122 includes a spoke receiving surface 132 having a rim to spoke interface 1003. The spokes 124 are received within a spoke interfacing structure 1001 of the spoke rim to spoke interface 1003. The spoke interfacing structure 1001 is at least partially located within the rim 122. The spoke interfacing structure 1001 is located at least partially at the inner circumference 134 of the rim 122. The spoke interfacing structure 1001 is located at least partially on the inside of the rim 122 at the spoke receiving surface 132. The spoke interfacing structure 1001 is located at least partially outside the rim 122 at the spoke receiving surface 132.

In the example of FIG. 20, the spoke interfacing structure 1001 includes spoke nipple 1002. In the example, the spoke nipple 1002 rests on the inside of the rim 122 at the spoke receiving surface 132. The spoke interfacing structure 1001 includes a spoke engaging structure 1004. In the example, the spoke engaging structure 1004 has a first end that interfaces with or connects to the spoke nipple 1002. The spoke engaging structure 1004 has a second end that receives the spoke 124. When the bicycle wheel is assembled, at least a portion of the spoke engaging structure 1004 passes through a spoke hole 1020 of the rim 122, so that the spoke nipple 1002 is within the rim 122 and the second end of the spoke engaging structure 1004 is outside the rim.

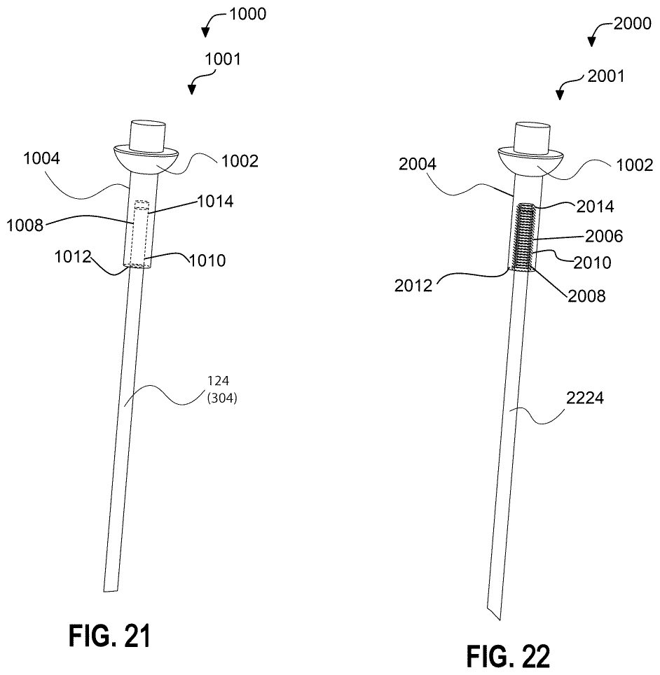

As seen in FIG. 21, the second end of the spoke engaging structure 1004 includes an opening 1012. The opening 1012 allows the spoke 124 to pass into a cavity 1010 sized and shaped to receive an end 1014 of spoke 124. In the example of FIG. 21, at least some adhesive 1008 secures the end 1014 of spoke 124 to the spoke engaging structure 1004. At least some adhesive 1008 exists between the inner surface of the cavity 1010 and the end 1014 of spoke 124 to secure the spoke 124 within the cavity 1010.

In an embodiment, the adhesive may be any type of adhesive capable of securing the end 1014 of the spoke 124 within the cavity 1010. For example, adhesives such as glue, tape, natural oils, and liquid adhesives may be used.

An alternate embodiment 2000 of a spoke interfacing structure 2001 is shown in FIG. 22. The embodiment of FIG. 22, the spoke engaging structure 2004 includes an opening 2012 for a spoke 2224 to travel into a cavity 2010. The inner surface of the cavity 2010 includes threads 2006. The threads 2006 of the cavity 2010 threadably engage with threads 2008 at an end 2014 of the spoke 2224. The spoke 2224 is threaded into the spoke engaging structure 2004 to secure the spoke 2224 to the rim of the bicycle, such as the rim 122.

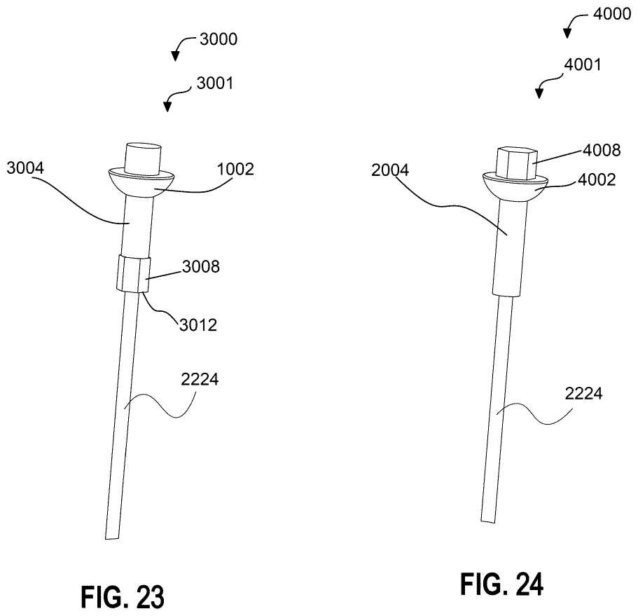

In an alternate embodiment 3000 of the spoke interfacing structure 3001 seen in FIG. 23, the spoke engaging structure 3004 is shorter in length than the spoke engaging structure 2004 shown in FIG. 22. The spoke interfacing structure 3001 includes a tension adjustment element 3008 at the second end of the spoke engaging structure 3004. The tension adjustment element 3008 includes an opening 3012 for receiving the spoke 2224. The tension adjustment element 3008 threadably engages with the threads 2008 at the end 2014 of the spoke 2224. When rotated, the tension adjustment element 3008 is capable of adjusting the tension of the spokes 2224.

The tension adjustment element 3008 may be a hex nut or other structure. In an embodiment, the tension adjustment element 3008 may be integrated with the spoke engaging structure 3004 as a single piece. In an alternate embodiment, the tension adjustment element 3008 may be a separate piece from the spoke engaging structure 3004.

An alternate embodiment 4000 of a spoke interfacing structure 4001 is seen in FIG. 24. The spoke interfacing structure 4001 differs from the spoke interfacing structure 3001 in that the tension adjustment element 4008 is located on top of the spoke nipple 4002 rather than at the second end of the spoke engaging structure 2004.

The tension adjustment element 4008 may be a hex nut or other structure. In an embodiment, the tension adjustment element 4008 may be integrated with the spoke nipple 4002 as a single piece. In an alternate embodiment, the tension adjustment element 4008 may be a separate piece from the spoke nipple 4002.

In an embodiment, the tension adjustment elements 3008 and/or 4008 may be configured to turn, alone or in combination with the rest of spoke interfacing structures 3001 and/or 4001, in order to adjust the spoke tension. In an embodiment, a tool may be used in order to turn the tension adjustment elements 3008 and/or 4008. In an alternate embodiment, no tool may be needed in order to turn the tension adjustment elements 3008 and/or 4008. The tension adjustment elements 3008 and/or 4008 may include a tool interface. In FIG. 2, the rim 122 includes a first sidewall 138 and a second sidewall that extend between the tire engaging portion 130 and the spoke engaging portion 136. For example, the first sidewall 138 and the second sidewall extend radially outward from the spoke engaging portion 136 to the tire engaging portion 130. The first sidewall 138 is spaced apart from the second sidewall.

The rim 122 may be made of any number of materials. For example, the rim 122 may be made of a metal (e.g., aluminum or an aluminum alloy). In one embodiment, at least part of the rim 122 (e.g., the spoke engaging portion 136 and/or the tire engaging portion 130) is formed by one or more composite materials (e.g., a carbon fiber composite material). In one embodiment, the entire rim 122 is formed by two or more composite materials. Other configurations may also be provided. For example, a combination of a first composite material and a second composite material forms a one-piece unitary rim of a collection of layers of the first composite material and layers of the second composite material including the tire engaging portion 130, the first sidewall 138, the second sidewall, and the spoke engaging portion 136.

The front wheel 54 and the rear wheel 56 may include rims 122 configured for any size wheel. In an embodiment, the rims 122 are configured for use in wheels conforming to wheel standards.

The front wheel 54 and the rear wheel 56 may rotate about the central hub 126 in either direction. For example, as shown in FIG. 2, the front wheel 54 and the rear wheel 56 may be configured to rotate in a particular rotational direction about the central hub 126. In another example, the front wheel 54 and the rear wheel 56 may be configured to rotate in a direction opposite the particular rotational direction.

In a manufacturing process, for each of the rims 122 (e.g., for the front wheel 54 and the rear wheel 56), layers of at least one composite material forming the first sidewall 138 and the second sidewall may be integrated with layers of one or more composite materials forming the spoke engaging portion 136 and the tire engaging portion 130 of the respective wheel 54, 56. A one-piece unitary rim 122 may then be formed using, for example, a curing process. The rims 122 of the front wheel 54 and rear wheel 56, respectively, may be formed with other manufacturing processes.

Referring to FIG. 2, the plurality of spokes 124 include first spokes 124a at a first side 160 of the respective wheel 54, 56 and second spokes 124b at a second side 162 of the respective wheel 54, 56. The first spokes 124a, together with a first flange 164 (e.g., a first faceted annulus), form a first spoke array 166, and the second spokes 124b, together with a second flange 168 (e.g., a second faceted annulus), form a second spoke array 170. The first spoke array 166 and the second spoke array 170 are each a single part. The first spoke array 166 and the second spoke array 170 are removably attached to the central hub 126, at or adjacent to opposite sides of the central hub, respectively.

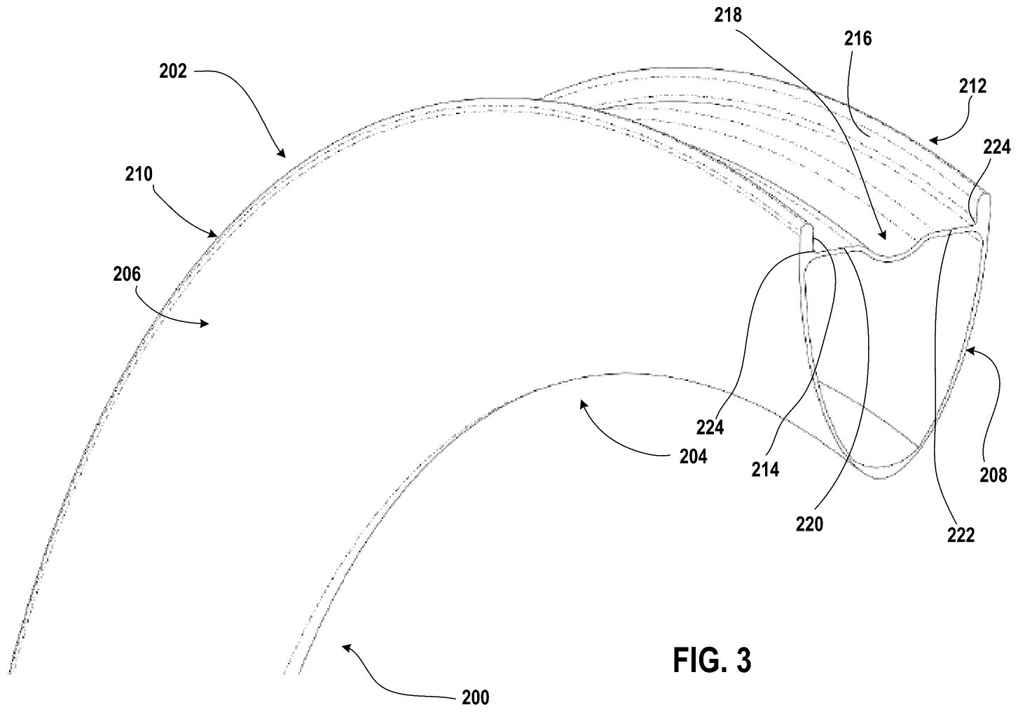

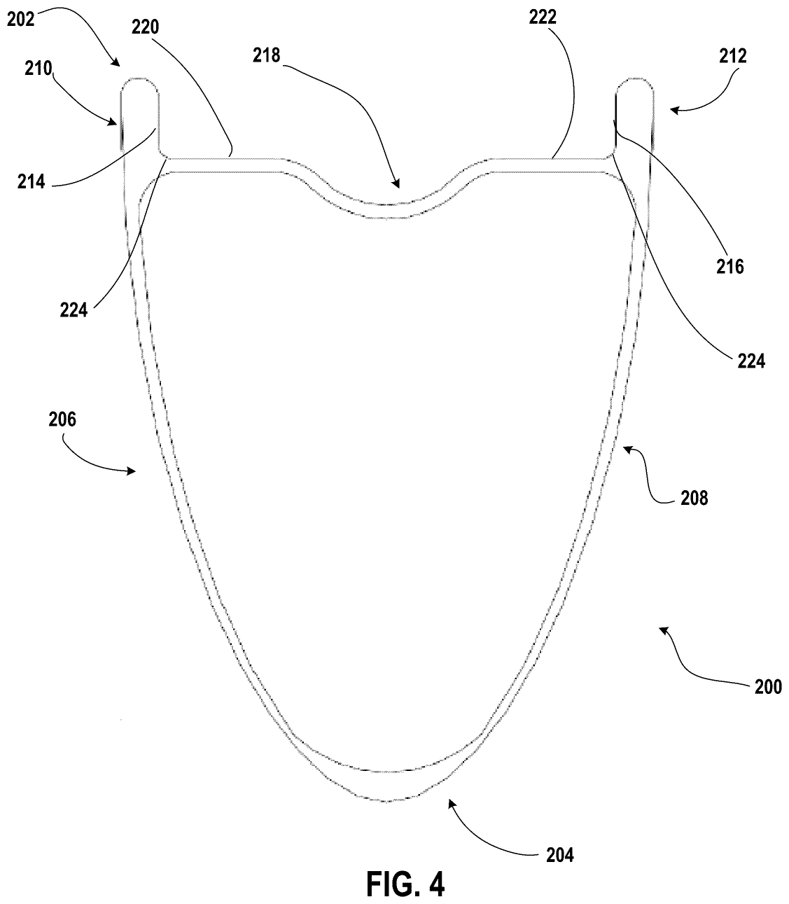

FIGS. 3 and 4 show an embodiment of a rim 200. In one embodiment, a layup pattern of layers of composite material for the rim is provided prior to a curing process, for example, to form the rim 200. The layers of composite materials, after the curing process, may be part of a one-piece unitary rim 200. The resultant one-piece unitary rim 200 may be formed by a composite laminate that includes one or more compressed layers of one or more composite materials. In another embodiment, the rim 200 is at least partially made of a metal such as, for example, aluminum or an aluminum alloy. In other embodiments, the rim 200 may be made of different, additional, and/or fewer materials.

Any number of composite materials may be included within the composite laminate. For example, the one or more composite materials of the composite laminate may include a first composite material, a second composite material, a third composite material, or any combination thereof. The composite laminate may include more or fewer composite materials. For example, the composite laminate may include only the first composite material and the second composite material, or may include only the second composite material and the third composite material. In one embodiment, the composite laminate includes only the first composite material, only the second composite material, or only the third composite material.

The first composite material may include a matrix of a polymer-based material (e.g., a first polymer-based material) and fibers of a reinforcing material (e.g., a first reinforcing material). The first polymer-based material may be any number of materials including, for example, a plastic, an acrylic, a resin, an epoxy, or any combination thereof, and the fibers of the second reinforcing material may be any number of materials including, for example, carbon. Other polymer-based materials and/or other reinforcing fibers may be used.

The second composite material may include a matrix of a polymer-based material (e.g., a second polymer-based material) and fibers of a reinforcing material (e.g., a second reinforcing material). The second polymer-based material may be any number of materials including, for example, a plastic, an acrylic, a resin, an epoxy, or any combination thereof, and the fibers of the second reinforcing material may be any number of materials including, for example, fiberglass. Other polymer-based materials and/or other reinforcing fibers may be used.

The third composite material may include a matrix of a polymer-based material (e.g., a third polymer-based material) and fibers of a reinforcing material (e.g., a third reinforcing material). The third polymer-based material may be any number of materials including, for example, a plastic, an acrylic, a resin, an epoxy, or any combination thereof, and the fibers of the third reinforcing material may be any number of materials including, for example, natural fibers. For example, the fibers of the third reinforcing material may be flax fibers, kenaf fibers, hemp fibers, jute fibers, or sisal fibers. Other polymer-based materials and/or other reinforcing fibers may be used.

The rim 200 includes a radially outer tire engaging portion 202 (e.g., disposed along an outer circumference of the rim 200), a radially inner portion 204 (e.g., a spoke engaging portion), a first sidewall 206, and a second sidewall 208 spaced apart from the first sidewall 206. The first sidewall 206 and the second sidewall 208 extend radially outward from the radially inner portion 204, to the radially outer tire engaging portion 202. The radially outer tire engaging portion 202 extends from the first sidewall 206 and the second sidewall 208, respectively.

The radially outer tire engaging portion 202 of the rim 200 includes a first tire retaining portion 210 and a second tire retaining portion 212 spaced apart from the first tire retaining portion 210. The first tire retaining portion 210 extends from the first sidewall 206, and the second tire retaining portion 212 extends from the second sidewall 208.

The first tire retaining portion 210 includes a first tire retaining wall 214. In one alternate embodiment, the first tire retaining portion 210 also includes a first protrusion (e.g., a first tire retaining feature) (not shown). The first protrusion may extend away from the first tire retaining wall 214. The first protrusion may be any number of shapes including, for example, a shape having a cross-section that is rectangular with a semi-circle cap. The first protrusion may extend circumferentially around the rim 200. The second tire retaining portion 212 includes a second tire retaining wall 216. The second tire retaining wall 216 is opposite and spaced apart from the first tire retaining wall 214. In one alternate embodiment, the second tire retaining portion 212 also includes a second protrusion (e.g., a second tire retaining feature) (not shown). The second protrusion may extend away from the second tire retaining wall 216, towards the first tire retaining portion 210. The second protrusion may be any number of shapes including, for example, a shape having a cross-section that is rectangular with a semi-circle cap. The second protrusion may extend circumferentially around the rim 200. The first protrusion and the second protrusion may be other shapes.

The rim 200 may seat a tire 120 (see FIG. 1) that is, for example, a tubeless tire. The tire 120 may include beads that interact with the radially outer tire engaging portion 202 (e.g., the first tire retaining portion 210 and the second tire retaining portion 212) of the rim 200 to attach the tire 120 to and maintain the tire 120 on the rim 200. The beads may include any number of materials within the beads, such as, for example, a steel wire or aramid (e.g., Kevlar™) fiber, to prevent the tire 120 from moving off of the rim 200. Due to the reinforcement with the steel wire or the Kevlar™ fiber, for example, the beads resist stretching from internal air pressure. Alternatively, the beads may be made of a same material as the tire 120 (e.g., rubber).

The radially outer tire engaging portion 202 also includes a well 218 positioned between the first tire retaining portion 210 and the second tire retaining portion 212 of the rim 200. The well 218 provides a volume into which the beads of the tire 120 may be placed when the tire 120 is being attached to the rim 200. As the tire 120 is inflated, the beads of the tire 120 move away from each other until the beads interact with the first tire retaining portion 210 and the second tire retaining portion 212, respectively. When inflated, the beads of the tire 120 abut the first tire retaining wall 214 and the second tire retaining wall 216, respectively. In one embodiment, the first tire retaining feature and the second tire retaining feature, for example, keep the beads of the tire 120 positioned within the radially outer tire engaging portion 202 (e.g., keep the beads of the tire 120 engaged with the first tire retaining wall 214 and the second tire retaining wall 216) and thus keep the tire 120 from blowing off the rim 200. The contact between the beads and the first tire retaining wall 214 and the second tire retaining wall 216, respectively, forms a seal between the inflated tire 120 and the rim 200.

The radially outer tire engaging portion 202 may also include ridges (e.g., bead bumps; a first bead bump and a second bead bump) on opposite sides of the well 218, respectively. A first shelf 220 (e.g., a first bead shelf) extends away from the first tire retaining wall 214 (e.g., between the first tire retaining wall 214 and the first bead bump), and a second shelf 222 (e.g., a second bead shelf) extends away from the second tire retaining wall 216 (e.g., between the second tire retaining wall 216 and the second bead bump). In one embodiment, curved transition regions 224 extend between the first shelf 220 and the first tire retaining wall 214, and the second shelf 222 and the second tire retaining wall 216, respectively. The bead bumps may be positioned on opposite sides of the well 218, respectively, and may be raised relative to the first shelf 220 and the second shelf 222, respectively. The bead bumps may help retain the tire 120 on the rim 200 if the tire 120 loses pressure.

In one embodiment, layers of the one or more composite materials (e.g., the first composite material, the second composite material, and/or the third composite material) are shaped as strips. A strip of a composite material (e.g., the first composite material) of the one or more composite materials may include fibers that extend along a finite length of the strip. In one embodiment, the fibers extend in a primary strength direction of the strip (e.g., along the length of the strip). For example, the strip has unidirectional fiber orientation along the length of the strip. In another embodiment, some of the fibers do not extend in the primary strength direction (e.g., less than 20 percent of the fibers, less than 10 percent of the fibers, or less than 5 percent of the fibers).

The strip may be any number of shapes and/or sizes. For example, the strip is rectangular in shape. Other shapes such as, for example, square shaped strips and non-rectangular parallelogram shaped strips, may be provided. The strip also includes a width that is perpendicular to the length of the strip. The length of the strip may be defined by a size of, for example, the radially outer tire engaging portion 202, the first sidewall 206, the second sidewall 208, and/or the radially inner portion 204 of the rim 200. In other words, the length of the strip may be at least as tall or wide as the radially outer tire engaging portion 202, the first sidewall 206, the second sidewall 208, and/or the radially inner portion 204 of the rim 200. In one embodiment, the width of the strip is between 10 mm and 50 mm. For example, the width of the strip is 30 mm. In other embodiments, the strip is wider or narrower (e.g., 60 mm). Smaller strip widths better optimize fiber orientation but come with a cost of added manufacturing complexity. In one embodiment, the width of the strip is as wide as a radial width of the rim 200.

Layers of different shapes, greater width, and/or greater length may be used. For example, at least some of the layers of the first composite material, for example, may extend a quarter, half, or all the way around the rim 200. Different sized and/or shaped layers of the first composite material, for example, may be used depending on the application within the rim 200 (e.g., forming an outer surface, providing strength and stiffness at a high load location within the rim).

The layers of the one or more composite materials may have any number of thicknesses. For example, thicknesses of the layers of the one or more composite materials may be 0.4 mm or thinner (e.g., 0.25 mm or thinner). Other thicknesses of the layers of the one or more composite materials may be provided.

For example, for one or more parts of the rim 200, each of a number of plies of a composite material of the one or more composite materials (e.g., the second composite material) may be unidirectional. The number of plies of the composite material may be stacked and sewn together, such that a checkered or hash pattern within a layer is formed. In other words, at least some of the number of plies of the composite material are unidirectional in different directions, respectively. The thickness of such a layer may be 1.2 mm or thicker. Other thicknesses may be provided.

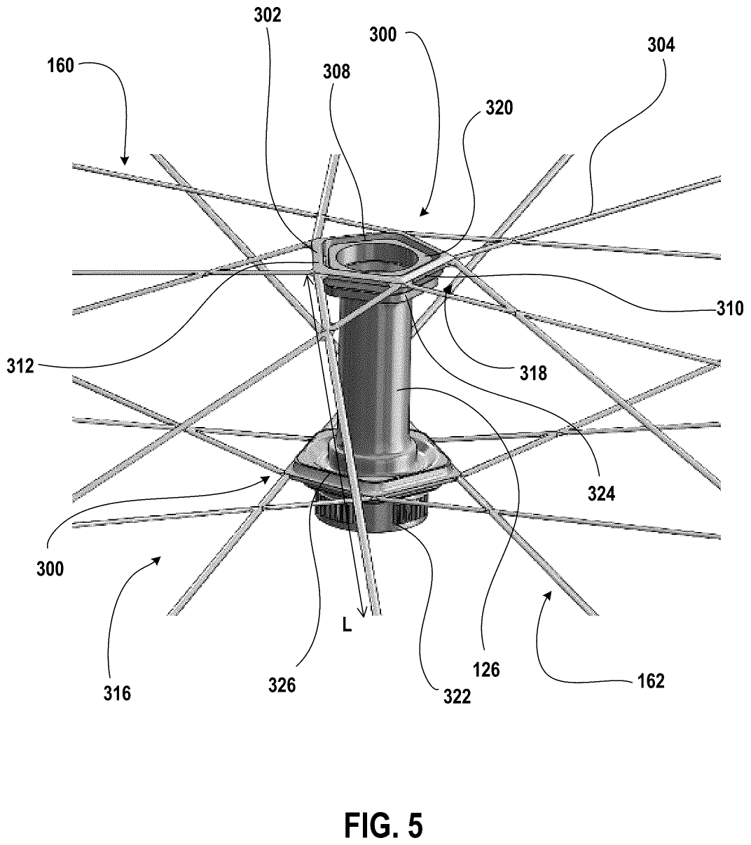

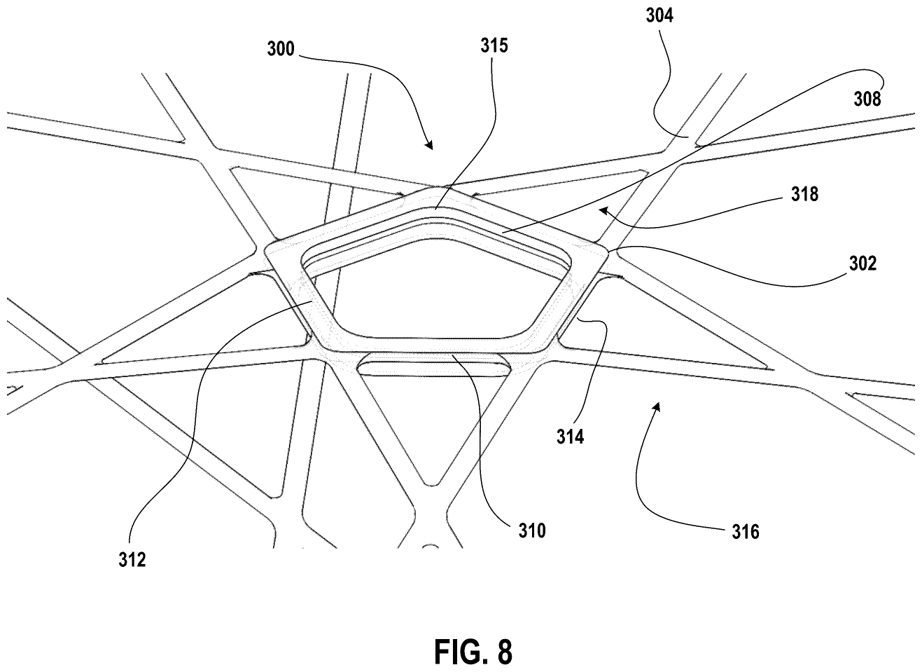

FIGS. 5-12 show a first embodiment of a spoke array 300 that is removably attachable to a central hub (e.g., the central hub 126) of a wheel (e.g., the front wheel 54 or the rear wheel 56) of a bicycle (e.g., the bicycle 50). The spoke array 300 forms all spokes on one side (e.g., the first side 160 or the second side 162) of the wheel of the bicycle. The spoke array 300 includes a central flange 302 and a plurality of spokes 304 integral with and extending away from the central flange 302, such that a single part is formed.

The plurality of spokes 304 may include any number of spokes 304. For example, as shown in FIGS. 5-12, the plurality of spokes 304 may include ten spokes integral with and extending away from the central flange 302. In other embodiments, the plurality of spokes 304 may include more or fewer spokes 304.

The plurality of spokes 304 and the central flange 302 may be made of any number of materials. (e.g., one or more materials). The one or more materials may include the first composite material. In one embodiment, the one or more materials include, alternatively or additionally, the second composite material, the third composite material, and/or one or more other materials (e.g., a metal, such as an alloy).

In one embodiment, the plurality of spokes 304 and the central flange 302 are made of a same material (e.g., the first composite material). In another embodiment, the plurality of spokes 304 and the central flange 302 are made of different materials (e.g., the first composite material and the second composite material, respectively). In yet another embodiment, subsets of spokes of the plurality of spokes 304 are made of different materials.

Each spoke of the plurality of spokes 304 extends away from the central flange 302. The plurality of spokes 304 may be bent or straight. In one embodiment, a first portion of spokes of the plurality of spokes 304 are bent, and a second portion of spokes of the plurality of spokes 304 are straight. A length L of each spoke of the plurality of spokes 304 is defined by a distance along the respective spoke extending away from the central flange 302, to an end 306 of the respective spoke 304. In one embodiment, all spokes of the plurality of spokes 304 have a same length L. In another embodiment, at least some spokes of the plurality of spokes 304 have different lengths L, respectively.

The central flange 302 may, for example, be a faceted annulus of any number of different shapes. The faceted annulus 302 may have one or more inner surfaces 308, one or more outer surfaces 310, a first side 312 (e.g., a top side), and a second side 314 (e.g., a bottom side) opposite the first side 312.

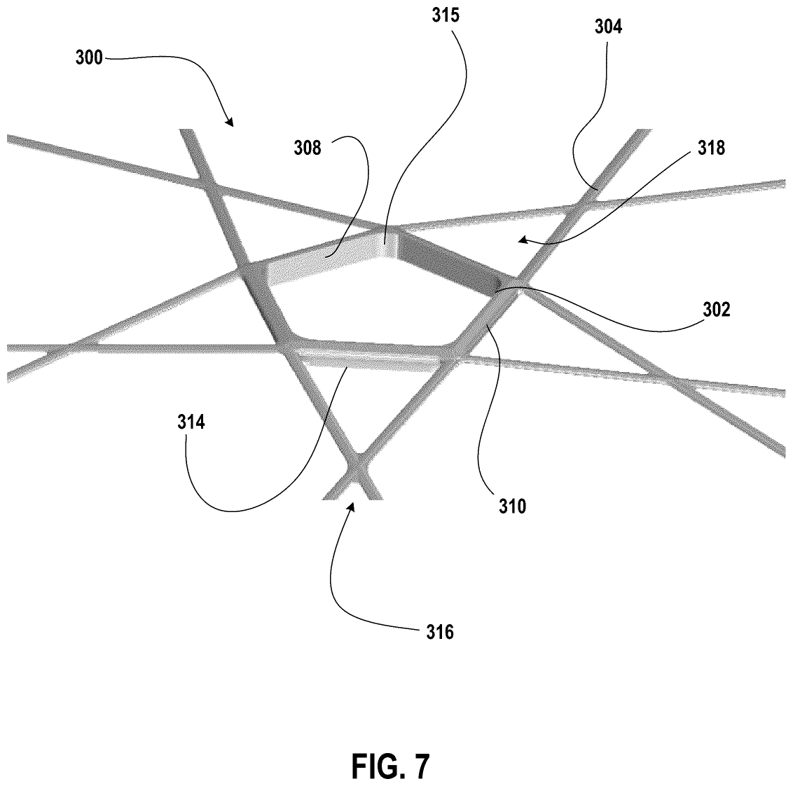

For example, referring to FIG. 7, the faceted annulus 302 may be shaped as a pentagon, and thus have five inner surfaces 308 (e.g., with rounded transitions 315 between adjacent inner surfaces of the five inner surfaces 308) and five outer surfaces 310. As discussed below, different shapes of the faceted annulus 302 may be provided.

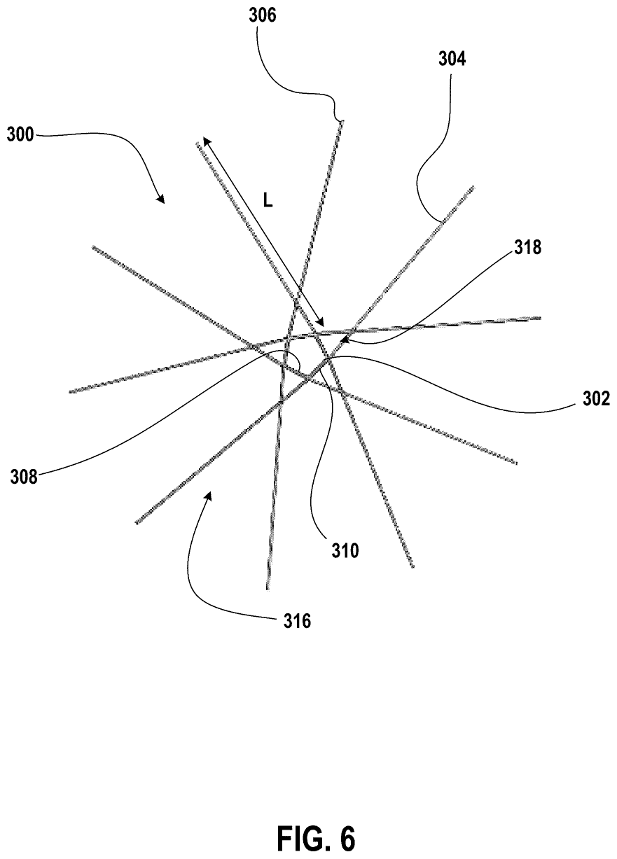

The first embodiment of the spoke array 300 of FIGS. 6-11 shows an example of a spoke pattern 316. Within the spoke pattern 316, pairs of spokes of the plurality of spokes 304 cross, such that triangles 318 (e.g., five triangles) are formed off of the five outer surfaces 310, respectively. The triangles 318 formed by the pairs of spokes 316 combined with the faceted annulus 302 shaped as a pentagon, forms a star shape. Such a spoke pattern 316 may provide strength for the wheel. In other embodiments, other spoke patterns may be provided.

Referring to FIGS. 5 and 9-12, the central hub 126 has a first end 320 and a second end 322 opposite the first end 320. The central hub 126 includes a first flange 324 that is adjacent to the first end 320 of the central hub 126 (e.g., closer to the first end 320 of the central hub 126 than to the second end 322 of the central hub 126), and a second flange 326 that is adjacent to the second end 322 of the central hub 126 (e.g., closer to the second end 322 of the central hub 126 than to the first end 320 of the central hub 126). The central hub 126 also includes a first boss 328 extending away from the first flange 324, between the first flange 324 and the first end 320 of the central hub 126, and a second boss 330 extending away from the second flange 326, between the second flange 326 and the second end 322 of the central hub 126.

A size and a shape (e.g., of an outer perimeter) of the first boss 328 may correspond to a size and a shape defined by the one or more inner surfaces 308 of the faceted annulus 302 of the spoke array 300. For example, the first boss 328 may include one or more outer surfaces 332 (e.g., five outer surfaces 332 with rounded transitions 334 between adjacent outer surfaces of the five outer surfaces 332). For example, the five outer surfaces 332 of the first boss 328 may be sized and the outer perimeter of the first boss 328 may be shaped, such that the five outer surfaces 332 of the first boss 328, for example, contact (e.g., abut) the five inner surfaces 308 of the faceted annulus 302, respectively, when the faceted annulus 302 is positioned about the first boss 328 and on the first flange 324. The first boss 328 may have any number of different heights. For example, the height of the first boss 328 may be greater than or equal to a thickness of the faceted annulus 302. Other sizes and/or shapes of the first boss 328 may be provided.

A size and a shape (e.g., of an outer perimeter) of the second boss 330 may correspond to a size and a shape defined by the one or more inner surfaces 308 of the faceted annulus 302 of the spoke array 300. For example, the second boss 330 may include one or more outer surfaces 336 (e.g., five outer surfaces 336 with rounded transitions 338 between adjacent outer surfaces of the five outer surfaces 336). For example, the five outer surfaces 336 may be sized and the outer perimeter of the second boss 330 may be shaped, such that the five outer surfaces 336 of the second boss 330, for example, contact the five inner surfaces 308 of the faceted annulus 302, respectively, when the faceted annulus 302 is positioned about the second boss 328 and on the second flange 326. The second boss 330 may have any number of different heights. For example, the height of the second boss 330 may be greater than or equal to a thickness of the faceted annulus 302. Other sizes and/or shapes of the second boss 330 may be provided.

The central hub 126 may include one or more first retention features 340 (e.g., a first retention feature 340) at the first boss 328 and/or the first flange 324. In one embodiment, the first retention feature 340 is a first detent feature. In one embodiment, the first detent feature 340 extends into the first boss 328 of the central hub 126. For example, the first detent feature 340 is a first groove that extends at least partly around the outer perimeter of the first boss 328. In one embodiment, the first groove 340 extends all of the way around the outer perimeter of the first boss 328 (e.g., is disposed within all outer surfaces of the one or more outer surfaces 332 of the first boss 328). In another embodiment, the first detent feature 340 is a protrusion that extends at least partly around the outer perimeter of the first boss 328 and extends away from the one or more outer surfaces 332 of the first boss 328.

The central hub 126 may also include one or more second retention features (e.g., a second retention feature; not shown) at the second boss 330 and/or the second flange 326. In one embodiment, the second retention feature is a second detent feature. In one embodiment, the second detent feature extends into the second boss 330 of the central hub 126. For example, the second detent feature is a second groove that extends at least partly around the outer perimeter of the second boss 330. In one embodiment, the second groove extends all of the way around the outer perimeter of the second boss 330 (e.g., is disposed within all outer surfaces of the one or more outer surfaces 336 of the second boss 330). In another embodiment, the second detent feature is a protrusion that extends at least partly around the outer perimeter of the second boss 330 and extends away from the one or more outer surfaces 336 of the second boss 330.

In other embodiments, the central hub 126 may include more and/or different retention features at the first boss 328 and/or the second boss 330. For example, the central hub 126 may include two or more first retention features 340 at the first boss 328 of the central hub 126 and/or may include two or more second retention features at the second boss 330 of the central hub 126. For example, the first boss 328 includes two grooves 340 spaced apart from each other within the first boss 328, and the second boss 330 includes two grooves spaced apart from each other within the second boss 330.

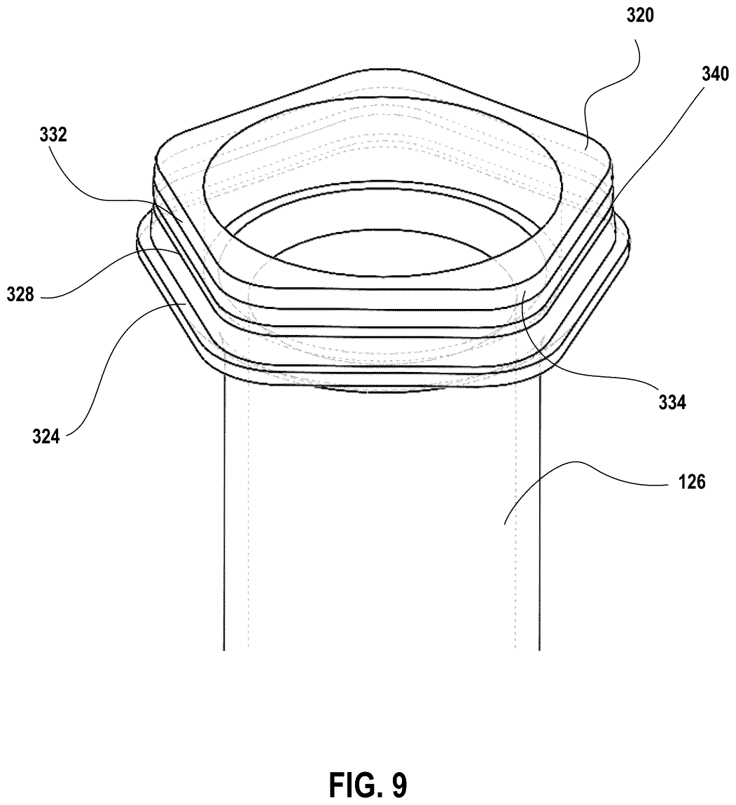

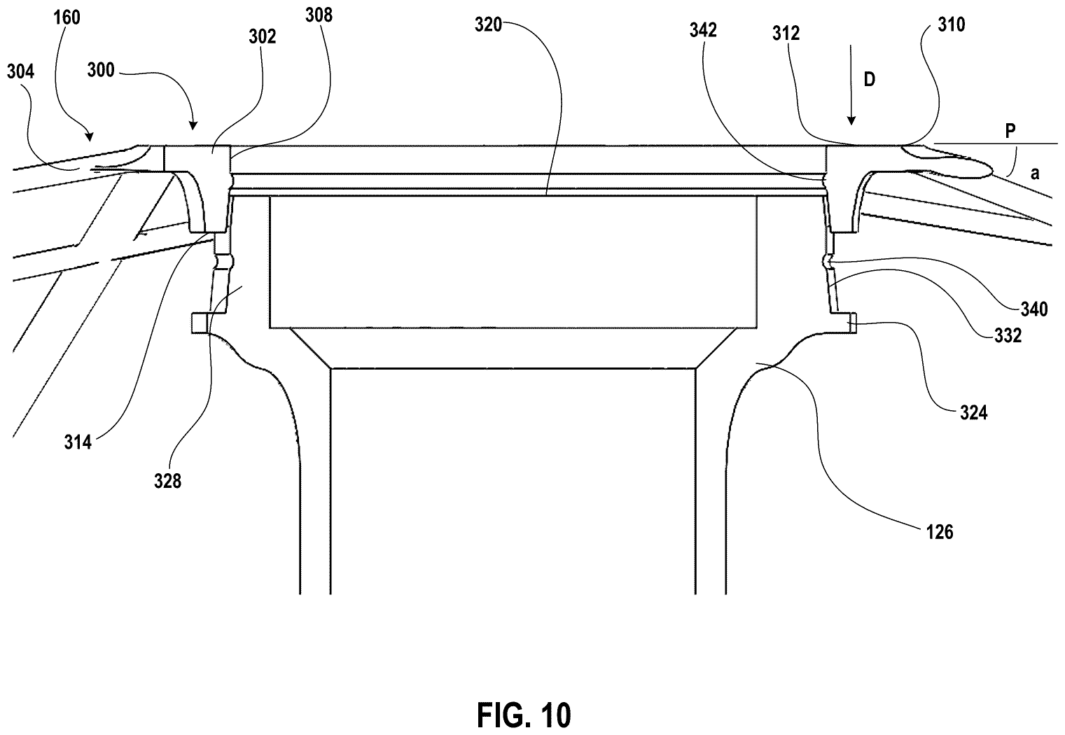

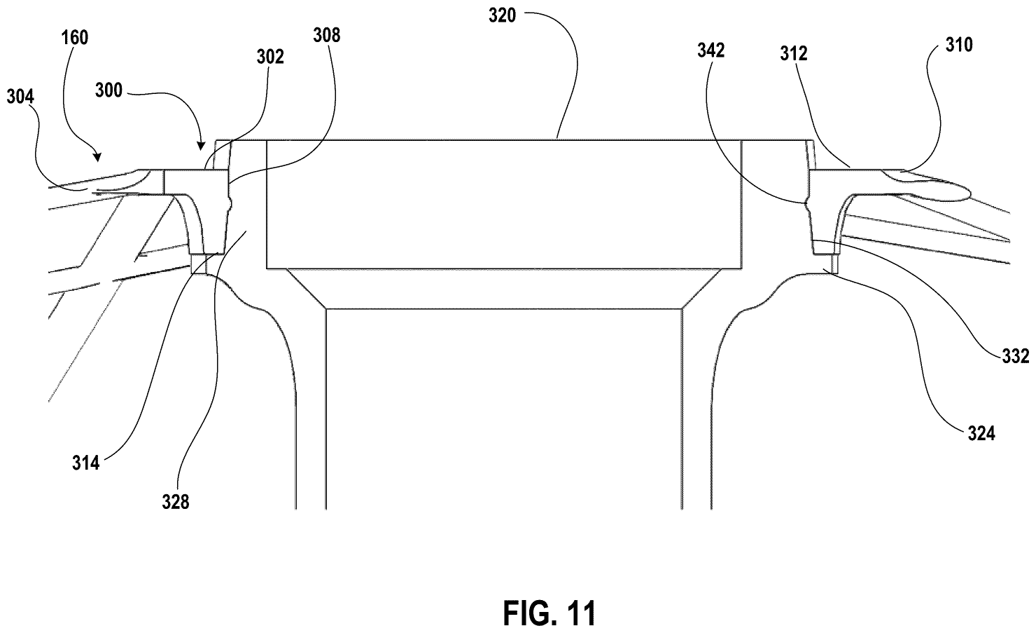

Referring to FIGS. 10 and 11, the faceted annulus 302 of the spoke array 300 includes one or more retention features 342 (e.g., a retention feature). For example, the faceted annulus 302 of the spoke array 300 includes the retention feature 342 at the one or more inner surfaces 308 of the faceted annulus 302. In one embodiment, the retention feature 342 is a detent feature that extends away from the one or more inner surfaces 308 of the faceted annulus 302, at least partly around an inner perimeter defined by the one or more inner surfaces 308 of the faceted annulus 302. For example, the detent feature 342 extends all the way around the inner perimeter of the faceted annulus 302. The detent feature 342 may be configured in any number of ways. For example, the detent feature 342 may be a protrusion or a rib extending all of the way around the inner perimeter of the faceted annulus 302.

The detent feature 342 may be sized and/or shaped in any number of ways. For example, the detent feature 342 is sized and shaped to correspond to the first retention feature 340 of the first boss 328 and/or the second retention feature of the second boss 330. In other words, one or more surfaces forming the detent feature 342 may contact one or more surfaces forming the first groove 340 of the first boss 328 or the second groove of the second boss 330, for example, when the spoke array 300 is positioned on the first boss 328 or the second boss 330 of the central hub 126.

In one embodiment, the faceted annulus 302 may include more and/or different retention features (e.g., at the one or more inner surfaces 308 of the faceted annulus 302). For example, the detent feature 342 may be a groove that corresponds to a protrusion on the first boss 328 of the central hub 126 and/or a protrusion on the second boss 330 of the central hub 126. In one embodiment, the faceted annulus 302 includes two or more detent features 342 at the one or more inner surfaces 308 of the faceted annulus 302. For example, the faceted annulus 302 includes two circumferential ribs 342 spaced apart from each other and extending away from the one or more inner surfaces 308 of the faceted annulus 302.

To attach the spoke array 300 to the central hub 126 (e.g., at the first end 320 or the second end 322 of the central hub 126), the faceted annulus 302 is disposed about the first boss 328 or the second boss 330, and the faceted annulus 302 is pushed down in a direction D (see FIG. 11) until the faceted annulus 302 contacts the first flange 324 or the second flange 326 of the central hub 126 and the detent feature 342 (e.g., the circumferential rib) engages with the first retention feature 340 or the second retention feature of the central hub 126. For example, as the faceted annulus 302 is pushed down in the direction D towards the first flange 324 or the second flange 326 of the central hub 126, the detent feature 342 moves into the first groove 340 or the second groove of the central hub 126, and the faceted annulus 302, and thus the spoke array 300, is locked at least translationally relative to the central hub 126.

The attachment process described with reference to FIGS. 10 and 11 may be repeated twice for each wheel (e.g., the front wheel 54 and the rear wheel 56). For example, a spoke array 300 may be attached to the central hub 126 at each of the first side 312 and the second side 314 of the central hub 126. All four of the spoke arrays 300 (e.g., for each side 312, 314 of each wheel 54, 56) may be configured in a same way. A brake rotor or an axle end cap may also act to mechanically capture the faceted annulus 302 of the spoke array 300.

In other embodiments, different subsets of the spoke arrays 300 may be configured differently. For example, spoke arrays 300 may be configured for particular sides of the wheel (e.g., at or adjacent to the first end 320 or the second end 322 of the hub 126; corresponding to the first side 160 or the second side 162 of the respective wheel 54, 56). For example, the different subsets of the spoke arrays 300 may include different detent features 342 corresponding to different grooves at and/or adjacent to the first end 320 and the second end 322 of the central hub 126, respectively (e.g., the first groove 340 and the second groove of the central hub 126). For example, the first groove 340 may be a different position along the first boss 328 relative to the first flange 324 than the second groove is along the second boss 330 relative to the second flange 326. In other words, a distance between the first flange 324 and the first groove 340 may be different than (e.g., greater than or less than) a distance between the second flange 326 and the second groove. Accordingly, different spoke arrays 300 may correspond to different central hubs 126, different sides of the central hub 126, and/or different wheels (e.g., the front wheel 54 or the rear wheel 56).

Other configurations may be provided. For example, spoke arrays for different wheels (e.g., the front wheel 54 and the rear wheel 56) may be configured differently. For example, the spoke array 300 shown in FIGS. 5-11 may be included within one of a front wheel (e.g., the front wheel 54) and a rear wheel (e.g., the rear wheel 56), and another spoke array may be included within the other of the front wheel and the rear wheel. For example, the other spoke array may include more, fewer, and/or different spokes integral with a faceted annulus.

The spoke array 300 may be removably attached to the central hub 126. For example, standard tools such as, for example, a flathead screwdriver may be used to remove spoke array 300 from the central hub 126. A user may wedge the screwdriver or another tool (e.g., a tool) with a flat edge between the faceted annulus 302 of the spoke array 300 and the first flange 324 or the second flange 326 of the central hub 126 and rotate or translate the tool to move the detent feature 342 of the spoke array 300, for example, out of the corresponding groove (e.g., the first groove 340), for example, of the central hub 126, allowing for translational movement of the spoke array 300 off of the central hub 126.

Referring to FIGS. 10 and 11, the plurality of spokes 304 may be at one or more angles (e.g., an angle a) relative to a plane P defined by the faceted annulus 302, such that each spoke of the plurality of spokes 304 extends to a central portion (e.g., an innermost portion) of a spoke receiving surface of a spoke engaging portion of a rim (e.g., the spoke engaging portion 204 of the rim 200). The plurality of spokes 304 may extend through the spoke receiving surface of the rim and may be connected to the rim within the rim. The plurality of spokes 304 may be connected to the rim in any number of ways. For example, ends of the plurality of spokes 304, respectively, may be threaded, and the plurality of spokes 304 may be connected to the rim via the threaded ends of the plurality of spokes 304 and threaded nipples. The plurality of spokes 304 may be connected to the rim in other ways.

The spoke array 300 may be used with (e.g., connected to) any number of different types of rims. For example, the spoke array 300 may be used with rims with protrusions configured as tire retaining features, single walled rims, double walled rims, tubular rims, and/or other types of rims.

The faceted annulus 302 of the spoke array 300 may be shaped in any number of different ways. For example, the faceted annulus 302 (e.g., the one or more inner surfaces 308 of the faceted annulus 302) of the spoke array 300 may be shaped as any number polygons. In one embodiment, the one or more inner surfaces 308 of the faceted annulus 302 form a shape with facets that are optimized for transferring torque loads between the central hub 126 and the plurality of spokes 304 of the spoke array 300. In different embodiments, the one or more inner surfaces 308 of the faceted annuls 302 may form a square, a pentagon, a hexagon, a septagon, an octagon, another polygon, a polygon with lobed interfaces, or another shape.

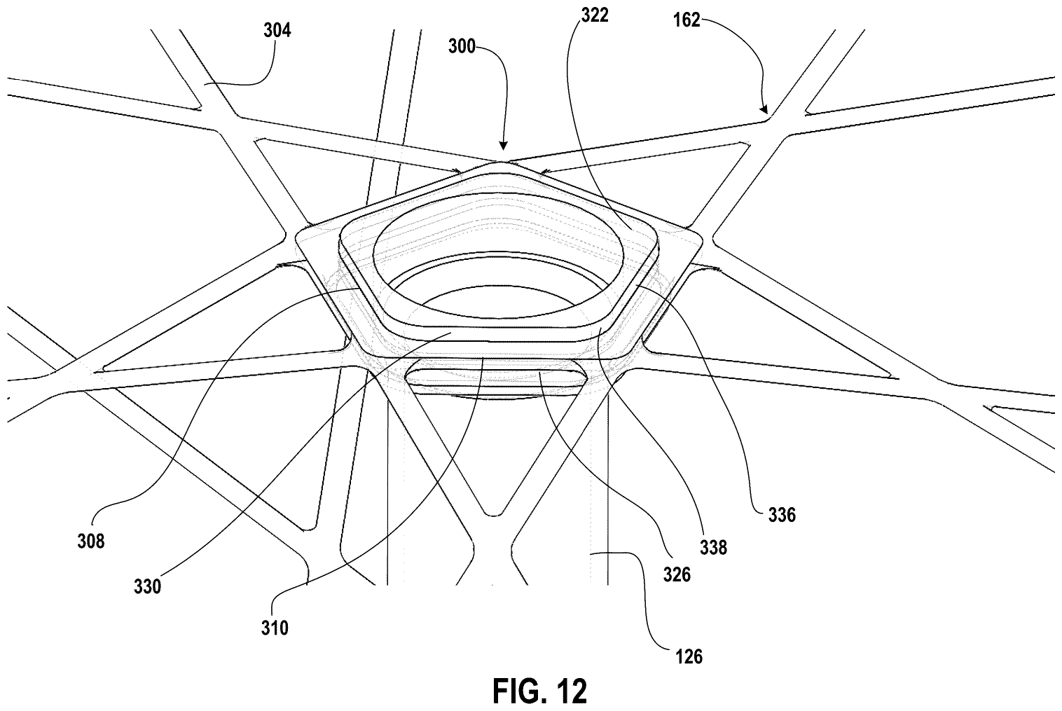

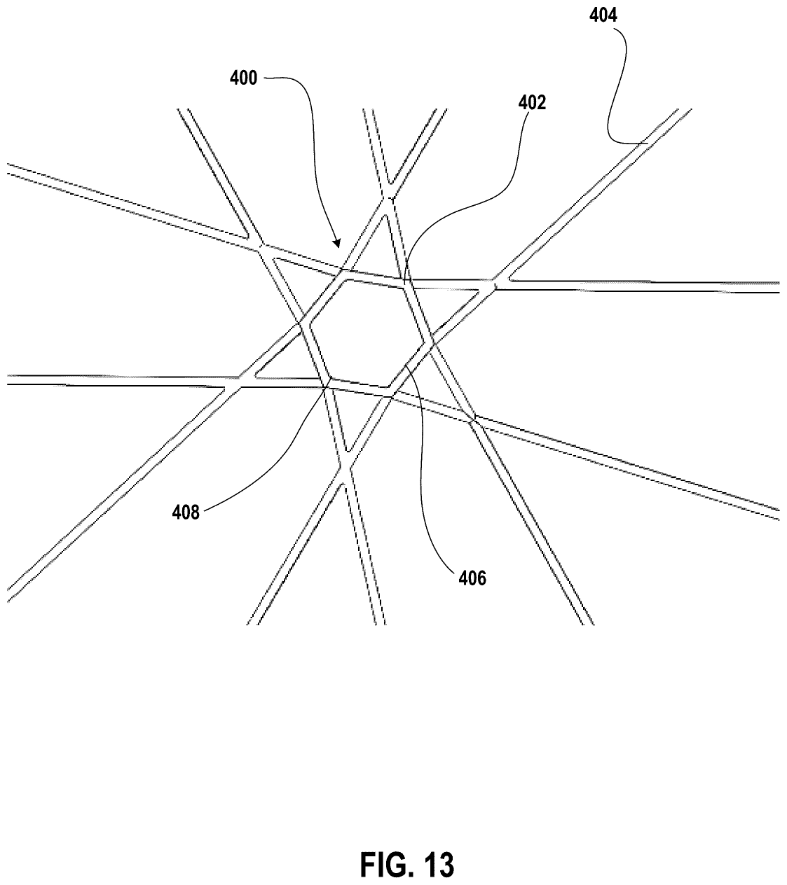

FIGS. 13-15 show examples of spoke arrays with central flanges having different shapes. FIG. 13 shows a spoke array 400 including a central flange 402 (e.g., a faceted annulus) and a plurality of spokes 404 integral with and extending away from the faceted annulus 402. The faceted annulus 402 has, for example, six inner surfaces 406 (e.g., and rounded transitions 408 between adjacent pairs of the six inner surfaces 406) that form a hexagon. With such an embodiment of the central flange 402, a central hub may include a first boss at a first end of the central hub and a second boss at a second end of the central hub, and outer surfaces of the first boss and outer surfaces of the second boss may form hexagons sized to match the hexagon formed by the inner surfaces of the faceted annulus 402.

FIG. 14 shows a spoke array 500 including a central flange 502 (e.g., a faceted annulus) and a plurality of spokes 504 integral with and extending away from the faceted annulus 502. The faceted annulus 502 has, for example, 24 inner surfaces 506 (e.g., and rounded transitions 508 between adjacent pairs of the 24 inner surfaces 506) that form a star polygon. With such an embodiment of the central flange 502, a central hub may include a first boss at a first end of the central hub and a second boss at a second end of the central hub, and outer surfaces of the first boss and outer surfaces of the second boss may form a star polygon sized to match the star polygon formed by the inner surfaces of the faceted annulus 502.

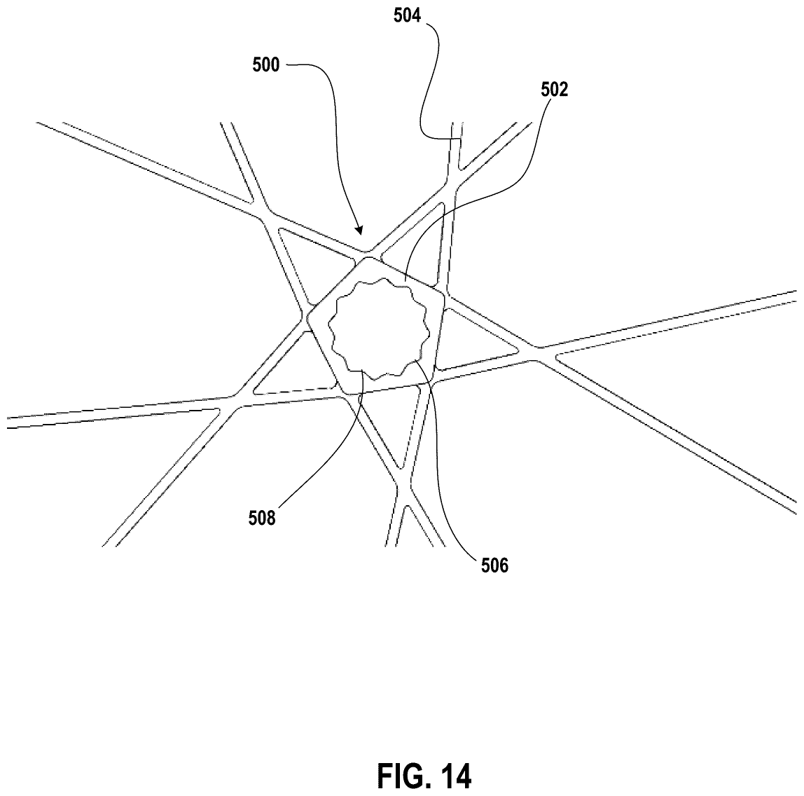

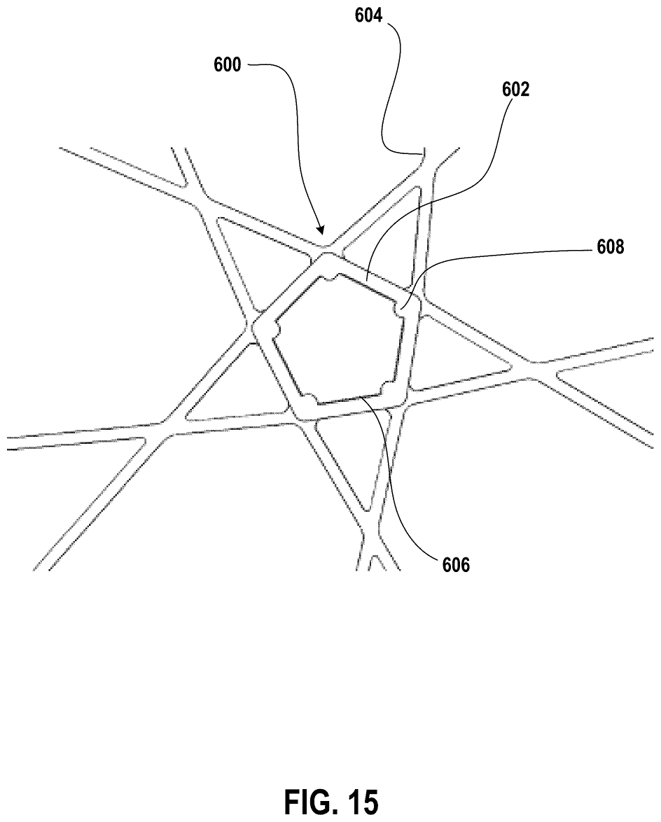

FIG. 15 shows a spoke array 600 including a central flange 602 (e.g., a faceted annulus) and a plurality of spokes 604 integral with and extending away from the faceted annulus 602. The faceted annulus 602 has, for example, five inner surfaces 606 that form a pentagon. With such an embodiment of the central flange 602, a central hub may include a first boss at a first end of the central hub and a second boss at a second end of the central hub, and outer surfaces of the first boss and outer surfaces of the second boss may form a pentagon sized to match the pentagon formed by the inner surfaces of the faceted annulus 602. The faceted annulus 602 may also include convexly curved transitions 608 (e.g., lobed interfaces) between adjacent pairs of the five inner surfaces 606.

In one embodiment, a layup pattern of layers of composite material for a spoke array (e.g., the spoke array 300, 400, 500, or 600) is provided prior to a curing process, for example, to form the spoke array 300. The layers of composite materials, after the curing process, may be part of a one-piece unitary spoke array 300. The resultant one-piece unitary spoke array 300 may be formed by a composite laminate that includes one or more compressed layers of one or more composite materials.

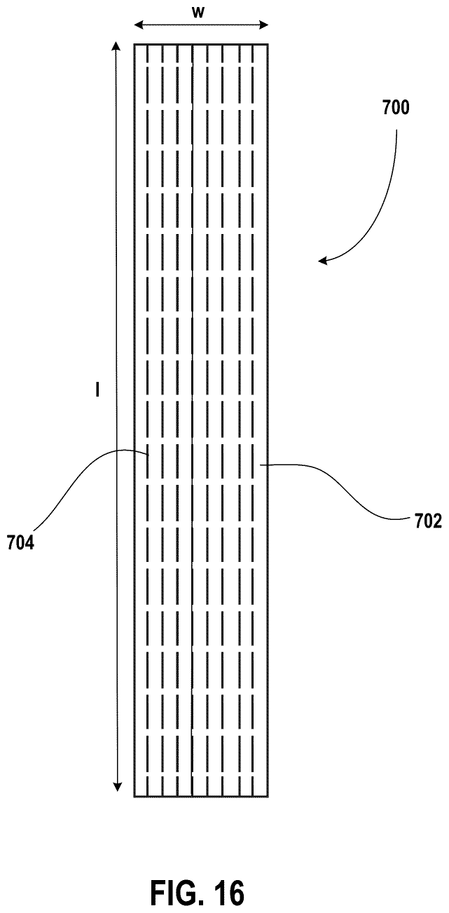

FIG. 16 illustrates one embodiment of a strip 700 of a composite material (e.g., the first composite material). The composite material includes a matrix 702 of a polymer-based material and fibers 704 of a reinforcing material. The polymer-based material may be any number of materials including, for example, a plastic, an acrylic, a resin, an epoxy, another polymer-based material, or any combination thereof. The fibers of the reinforcing material may be carbon fibers. Other polymer-based materials and/or other reinforcing fibers may be used.

The fibers 704 extend along a finite length l of the strip 700. In one embodiment, the fibers 704 extend in a primary strength direction of the strip 700 (e.g., along the length l of the strip 700). For example, the strip 700 has unidirectional fiber orientation along the length l. In another embodiment, some of the fibers 700 do not extend in the primary strength direction (e.g., less than 20 percent of the fibers, less than 10 percent of the fibers, or less than 5 percent of the fibers). The strip 700 may be any number of shapes and/or sizes. For example, the strip 700 is rectangular in shape. Other shapes such as, for example, square shaped strips and non-rectangular parallelogram shaped strips, may be provided. The strip 700 also includes a width w that is perpendicular to the length l. The length l may be partially defined by a length of, for example, a spoke of the plurality of spokes 304 of the spoke array. In one embodiment, the width w of the strip 700 is between 10 mm and 30 mm. For example, the width w of the strip 700 is 20 mm. In other embodiments, the strip 700 is wider or narrower. Smaller strip widths better optimize fiber orientation but come with a cost of added manufacturing complexity.

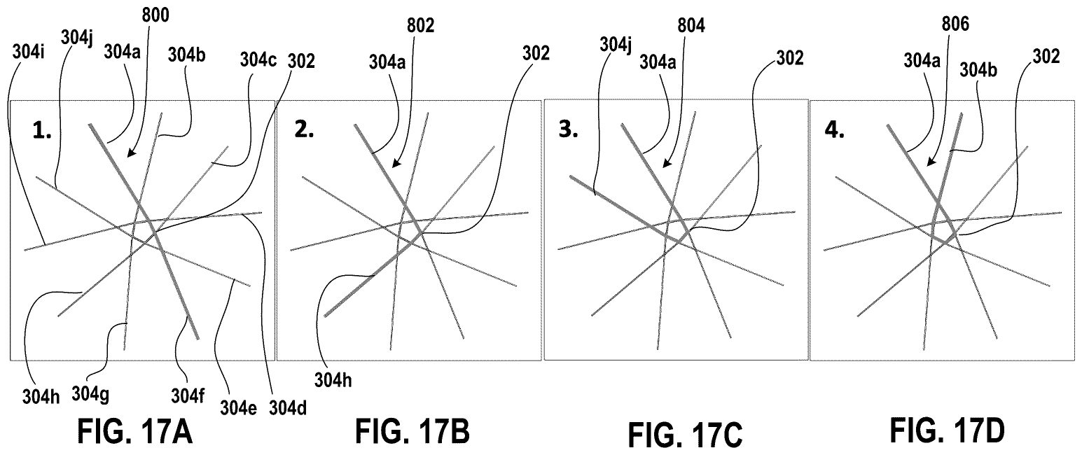

The strips 700, for example, provide ultimate strength in a direction of fiber grain. Accordingly, fiber alignment along spokes of the plurality of spokes 304, for example, may be provided. FIGS. 17A-D show examples of continuous fiber paths within the spoke array 300, for example. In the examples of FIGS. 17A-D, the plurality of spokes 304, for example, include ten spokes 304a-304j. In a first example in FIG. 17A, a continuous fiber path 800 forms a first spoke 304a and a sixth spoke 304f of the plurality of spokes 304. The first spoke 304a and the sixth spoke 304f are at an obtuse angle relative to each other (e.g., 160 degrees or 165 degrees). The continuous fiber path 800 forms part of the faceted annulus 302 (e.g., at least part of one side of the faceted annulus 302). The continuous fiber path 800 is repeated four additional times to form remaining spokes of the plurality of spokes 304 (e.g., second spoke 304b, third spoke 304c, fourth spoke 304d, fifth spoke 304e, seventh spoke 304g, eighth spoke 304h, ninth spoke 304i, and tenth spoke 304j) and a remainder of the faceted annulus 302.

In a second example in FIG. 17B, a continuous fiber path 802 forms the first spoke 304a and the eighth spoke 304h of the plurality of spokes 304. The first spoke 304a and the eighth spoke 304h are at an obtuse angle relative to each other (e.g., 100 degrees or 115 degrees). The obtuse angle illustrated by the continuous fiber path 802 of FIG. 17B is smaller than the obtuse angle illustrated by the continuous fiber path 800 of FIG. 17A. The continuous fiber path 802 forms part of the faceted annulus 302 (e.g., at least part of two sides of the faceted annulus 302). The continuous fiber path 802 is repeated four additional times to form remaining spokes of the plurality of spokes 304 (e.g., second spoke 304b, third spoke 304c, fourth spoke 304d, fifth spoke 304e, sixth spoke 304f, seventh spoke 304g, ninth spoke 304i, and tenth spoke 304j) and a remainder of the faceted annulus 302.

In a third example in FIG. 17C, a continuous fiber path 804 forms the first spoke 304a and the tenth spoke 304j of the plurality of spokes 304. The first spoke 304a and the tenth spoke 304j are at an acute angle relative to each other (e.g., 35 degrees or 40 degrees). The continuous fiber path 804 forms part of the faceted annulus 302 (e.g., at least part of threes side of the faceted annulus 302). The continuous fiber path 804 is repeated four additional times to form remaining spokes of the plurality of spokes 304 (e.g., second spoke 304b, third spoke 304c, fourth spoke 304d, fifth spoke 304e, sixth spoke 304f, seventh spoke 304g, eighth spoke 304h, and ninth spoke 304i) and a remainder of the faceted annulus 302.

In a fourth example in FIG. 17D, a continuous fiber path 806 forms the first spoke 304a and the second spoke 304b of the plurality of spokes 304. The first spoke 304a and the second spoke 304b are at an acute angle relative to each other (e.g., 40 degrees or 45 degrees). The acute angle illustrated by the continuous fiber path 806 of FIG. 17D may be less than, equal to, or greater than the acute angle illustrated by the continuous fiber path 804 of FIG. 17C. The continuous fiber path 806 forms part of the faceted annulus 302 (e.g., at least part of four sides of the faceted annulus 302). The continuous fiber path 806 is repeated four additional times to form remaining spokes of the plurality of spokes 304 (e.g., third spoke 304c, fourth spoke 304d, fifth spoke 304e, sixth spoke 304f, seventh spoke 304g, eighth spoke 304h, ninth spoke 304i, and tenth spoke 304j) and a remainder of the faceted annulus 302. In other embodiments, other continuous fiber paths may be provided.

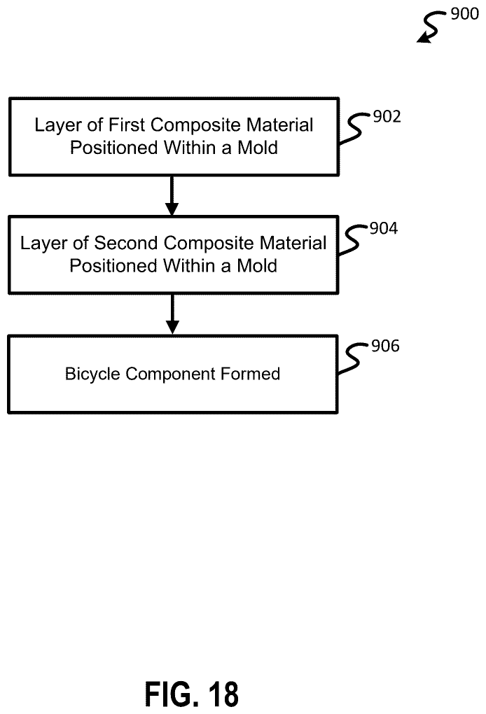

FIG. 18 illustrates a method 900 for manufacturing a bicycle component (e.g., the spoke array 300) of a bicycle (e.g., the bicycle 50). The acts of the method 900 presented below are intended to be illustrative. In some embodiments, the method 900 may be accomplished with one or more additional acts not described, and/or without one or more of the acts described. Additionally, the order in which the acts of the method 900 are illustrated in FIG. 18 and described below is not intended to be limiting.

In act 902, at least one layer (e.g., a layer) of a first composite material is positioned within a mold. The first composite material includes a matrix of a first polymer-based material and fibers of a first reinforcing material. In one embodiment, fiber orientation of the fibers of the first reinforcing material of the layer of the first composite material is unidirectional in a direction along a length of the respective layer.

The layer of the first composite material may be any number of shapes and/or sizes. For example, the layer of the first composite material may be rectangular in shape and may have a length at least as long as two times a length of a spoke of a wheel to be manufactured. Other shapes and/or sizes may be provided.

The first polymer-based material may be or include any number of polymer-based materials including, for example, a thermoplastic, a thermoset matrix, or a combination thereof. The fibers of the first reinforcing material may be or include any number of different types of fibers including, for example, carbon fibers, fiberglass fibers, flax fibers, kenaf fibers, hemp fibers, jute fibers, sisal fibers, or any combination thereof. Other polymer-based materials and/or other reinforcing materials may be used for the first composite material.

In one embodiment, the layer of the first composite material is positioned within the mold, such that the layer of the first composite material forms at least part of a spoke and a central flange (e.g., a faceted annulus) of the spoke array to be manufactured. In other embodiments, the layer of the first composite material is positioned within the mold, such that the layer of the first composite material forms at least part of another portion of the spoke array to be manufactured (e.g., another spoke of the spoke array).

In act 904, at least one layer (e.g., a layer) of a second composite material is positioned within the mold, such that the layer of the second composite material abuts and/or overlaps with the layer of the first composite material (e.g., within the faceted annulus). The second composite material includes a matrix of a second polymer-based material and fibers of a second reinforcing material. The second polymer-based material may be the same or different than the first polymer-based material, and/or the second reinforcing material may be the same or different than the first reinforcing material.

The second polymer-based material may be or include any number of polymer-based materials including, for example, a plastic, an acrylic, a resin, an epoxy, or any combination thereof. The fibers of the second reinforcing material may be or include any number of different types of fibers including, for example, carbon fibers, fiberglass fibers, flax fibers, kenaf fibers, hemp fibers, jute fibers, sisal fibers, or any combination thereof. Other polymer-based materials and/or other reinforcing materials may be used for the second composite material.

The layer of the second composite material may be any number of shapes and/or sizes. For example, the layer of the second composite material may be rectangular in shape and may have a length at least as long as twice a length of a spoke of the spoke array to be manufactured. Other shapes and/or sizes may be provided. In one embodiment, the layer of the second composite material is longer than the layer of the first composite material. In another embodiment, the layer of the second composite material is the same size (e.g., length) than the layer of the first composite material.

In one embodiment, the layer of the second composite material is positioned within the mold, such that the layer of the second composite material forms at least part of a spoke and the faceted annulus of the spoke array to be manufactured. In other embodiments, the layer of the second composite material is positioned within the mold, such that the layer of the second composite material forms at least part of another portion of the spoke array to be manufactured (e.g., another spoke of the spoke array).

Act 902 and/or act 904 may be repeated any number of times to form a layup pattern for the bicycle component. In one embodiment, act 902 and/or act 904 may be repeated with one or more additional acts, in which one or more layers of other composite materials are positioned any number of times to, for example, form a layup pattern. For example, the second composite material may be the same as the first composite material, and act 904 may be repeated three additional times, such that the layup pattern is for ten spokes.

In act 906, the bicycle component is formed. Forming the bicycle component includes forming a composite laminate (e.g., lamination) that includes at least the layer of the first composite material and the layer of the second composite material within the mold. In one embodiment, forming the bicycle component includes forming the composite laminate that includes at least the layer of the first composite material, the layer of the second composite material, and a layer of a third composite material (e.g., the same or different than the first composite material and/or the second composite material) within the mold.

The mold may be used to form all or part of the bicycle component. For example, for a spoke array, the mold may be broken up into multiple parts to allow access to the mold when positioning at least the layer of the first material in act 902 and the layer of the second material in act 904. For example, the mold may be broken up into multiple radial portions (e.g., two radial portions) and/or multiple pieces (e.g., a top piece and a bottom piece).

Forming the composite laminate may include shaping and curing the composite laminate within, for example, the mold. For example, at least the layer of the first composite material and the layer of the second composite material may be positioned within the mold and shaped using a bladder inflated within the mold. The composite laminate may be shaped in other ways.

Once shaped, the composite laminate may be cured in any number of ways including, for example, by press curing, autoclave curing, or oven curing the composite laminate that includes at least the layer of the first composite material and the layer of the second composite material. Other types of curing may be used.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A wheel for a bicycle, the wheel comprising:
a central hub having a first end and a second end opposite the first end, wherein the central hub is configured for rotational attachment to the bicycle;
a rim comprising a radially inner portion disposed along an inner circumference of the rim;
a first spoke array removably attached to the central hub and the radially inner portion of the rim, the first spoke array being at a first side of the wheel and comprising:
a first central flange; and
a plurality of first spokes integral with and extending away from the first central flange, such that a first single part is formed; and
a second spoke array removably attached to the central hub and the radially inner portion of the rim, the second spoke array being at a second side of the wheel, the second side of the wheel being opposite the first side of the wheel, the second spoke array comprising:
a second central flange; and
a plurality of second spokes integral with and extending away from the second central flange, such that a second single part is formed.

2. The wheel of claim 1, wherein the central hub comprises a first flange and a second flange, the first flange being closer to the first end of the central hub than the second end of the central hub, and the second flange being closer to the second end of the central hub than the first end of the central hub, and
wherein the first spoke array is removably attached to the first flange of the central hub, and the second spoke array is removably attached to the second flange of the central hub.

3. The wheel of claim 1, wherein the first central flange and the plurality of first spokes of the first spoke array are made of a first material, and the second central flange and the plurality of second spokes of the second spoke array are made of a second material.

4. The wheel of claim 3, wherein the first material and the second material are a same carbon fiber composite material.

5. The wheel of claim 3, wherein the rim further comprises:
a first sidewall;
a second sidewall spaced apart from the first sidewall, wherein the first sidewall and the second sidewall extend radially outward from the radially inner portion; and
a radially outer tire engaging portion disposed along an outer circumference of the rim, the radially outer tire engaging portion extending from the first sidewall and the second sidewall, respectively, and
wherein the first sidewall, the second sidewall, the radially outer tire engaging portion, and the radially inner portion of the rim are made of a third material, the third material being a carbon fiber composite material.

6. The wheel of claim 2, wherein the first central flange is a first faceted annulus, and the second central flange is a second faceted annulus.

7. The wheel of claim 6, wherein each of the first faceted annulus and the second faceted annulus has an inner surface that is shaped as a square, a pentagon, a hexagon, a septagon, or an octagon.

8. The wheel of claim 7, wherein the central hub further comprises a first boss extending between the first flange and the first end, and a second boss extending between the second flange and the second end, and
wherein an outer surface of the first boss is a same shape as the inner surface of the first faceted annulus, and an outer surface of the second boss is a same shape the inner surface of the second faceted annulus.

9. The wheel of claim 8, wherein the first boss comprises a first retention feature at the outer surface of the first boss, and the first faceted annulus comprises a second retention feature at the inner surface of the first faceted annulus, the second retention feature being configured to interact with the first retention feature, such that the first spoke array is attached to the central hub, and
wherein the second boss comprises a third retention feature at the outer surface of the second boss, and the second faceted annulus comprises a fourth retention feature at the inner surface of the second faceted annulus, the fourth retention feature being configured to interact with the third retention feature, such that the second spoke array is attached to the central hub.

10. The wheel of claim 9, wherein the first retention feature is a first detent feature that extends into the first boss, and the second retention feature is a second detent feature that extends away from the inner surface of the first faceted annulus, and
wherein the third retention feature is a third detent feature that extends into the second boss, and the fourth retention feature is a fourth detent feature that extends away from the inner surface of the second faceted annulus.

11. The wheel of claim 1, further comprising a spoke interfacing structure, the spoke interfacing structure including a spoke nipple, a spoke engaging structure, and a tension adjustment element,
wherein the tension adjustment element is located within the rim, above the spoke nipple.

12. A spoke array that is removably attachable to a central hub and a rim of a wheel for a bicycle, such that the spoke array forms all spokes of one side of the wheel, the spoke array comprising:
a central flange; and
a plurality of spokes integral with and extending away from the central flange, such that a single part is formed.

13. The spoke array of claim 12, wherein the central flange and the plurality of spokes integral with the central flange are made of a carbon fiber composite material, and
wherein the carbon fiber composite material includes a matrix of a polymer-based material and fibers of reinforcing material, the fibers of reinforcing material being carbon fibers.

14. The spoke array of claim 13, wherein a continuous fiber of the carbon fibers extends from a first spoke of the plurality of spokes to a second spoke of the plurality of spokes via the central flange.

15. The spoke array of claim 14, wherein the first spoke is at an angle relative to the second spoke.

16. The spoke array of claim 15, wherein the angle is an acute angle.

17. The spoke array of claim 12, wherein the central flange is a faceted annulus having an inner surface that is shaped as a square, a pentagon, a hexagon, a septagon, or an octagon.

18. The spoke array of claim 12, wherein the faceted annulus comprises a retention feature at an inner surface of the faceted annulus.

19. The spoke array of claim 18, wherein the retention feature is a protrusion extending from the inner surface of the faceted annulus, radially inwardly.

20. The spoke array of claim 19, wherein the protrusion is a circumferential rib extending around a circumference of the inner surface of the faceted annulus.
